(19) United States
(12) Patent Application Publication
(10) Pub. No.: US 2025/0292548 A1
(43) Pub. Date: Sep. 18, 2025

(54) METHODS AND APPARATUSES FOR CONSTRUCTING DATASET FOR MODEL TRAINING

(71) Applicant: Alipay (Hangzhou) Information Technology Co., Ltd., Hangzhou (CN)

(72) Inventors: Qing Wang, Hangzhou (CN); Wang Ren, Hangzhou (CN); Jian Wang, Hangzhou (CN); Qingpei Guo, Hangzhou (CN)

(73) Assignee: Alipay (Hangzhou) Information Technology Co., Ltd., Hangzhou (CN)

(21) Appl. No.: 19/079,792

(22) Filed: Mar. 14, 2025

(30) Foreign Application Priority Data
Mar. 15, 2024 (CN) 202410303824.X

(51) Int. Cl. G06V 10/774; G06F 40/279; G06F 40/40; G06V 10/764; G06V 10/77

(52) U.S. Cl. CPC G06V 10/774; G06F 40/279; G06F 40/40; G06V 10/764; G06V 10/7715

(57) ABSTRACT

Implementations of this specification provide methods and apparatuses for model training. One example method includes: obtaining a first dataset that comprises a plurality of initial image-text pairs, calculating a similarity score between an initial image and an initial text comprised in each of the plurality of initial image-text pair, classifying each of the plurality of initial image-text pairs as one of high-quality data, medium-quality data, or low-quality data based on the similarity score and a predetermined score threshold, and adding updated image-text pairs classified as the medium-quality data and initial image-text pairs classified as the high-quality data to a second dataset for model training.

### CROSS-REFERENCE TO RELATED APPLICATIONS

This application claims priority to Chinese Patent Application No. 202410303824.X, filed on Mar. 15, 2024, which is hereby incorporated by reference in its entirety.

### TECHNICAL FIELD

One or more embodiments of this specification relate to the computer field, and in particular, to methods and apparatuses for constructing a dataset for model training.

### BACKGROUND

Artificial intelligence is developing from unimodal intelligence in areas such as text, speech, and vision to general artificial intelligence that integrates a plurality of modalities. Unified multimodal modeling is performed to enhance a cross-modal semantic alignment capability of a model, open up a relationship between modalities, and gradually standardize the model. Constructing a unified, cross-scenario, and multi-task multimodal foundation model based on multi-domain knowledge has become a crucial development direction of artificial intelligence. In the future, as an infrastructure, a multimodal large model implements unified knowledge representation of images, texts, and audio, and evolves towards cognitive intelligence with capabilities of inference, question answering, summarization, and creation. The multimodal large model can have tens of billions or even hundreds of billions of parameters. To construct a model with such a large quantity of parameters, large-scale image-text training data are a basis for implementing all the above-mentioned capabilities. For example, the image-text training data need to have a scale of billions.

To ensure a model training effect, the large-scale image-text training data usually need to satisfy specific needs. For example, the training data need to be of high quality, do not involve personal privacy, and can help the model actively establish a strong enough association between image and text content by using a self-supervised learning method without manual labeling, so as to determine syntax, semantics, and syntax structures of natural languages and understand scenarios, objects, and characters in images. However, training data obtained in the conventional technology may be of low quality, and it is difficult to obtain a sufficient amount of training data satisfying needs, resulting in a poor model training effect.

### SUMMARY

One or more embodiments of this specification describe methods and apparatuses for constructing a dataset for model training, so that a sufficient amount of training data satisfying needs can be obtained, to improve a model training effect.

According to a first aspect, a method for constructing a dataset for model training is provided. The method includes: obtaining a first dataset, where the first dataset includes several initial image-text pairs; for any initial image-text pair in the first dataset, calculating a similarity score between an initial image and an initial text included in the initial image-text pair; classifying each initial image-text pair in the first dataset into high-quality data, medium-quality data, or low-quality data based on the similarity score and a predetermined score threshold; for any initial image-text pair belonging to the medium-quality data, extracting an initial image included in the initial image-text pair, generating a corresponding text description based on the initial image, and forming an updated image-text pair by using the initial image and the corresponding text description; and adding all updated image-text pairs and all initial image-text pairs belonging to the high-quality data to a second dataset, where the second dataset is used as a dataset for model training.

In a possible implementation, the obtaining a first dataset includes: obtaining a first quantity of initial image-text pairs from a plurality of data sources, and analyzing a keyword that matches each initial image-text pair; selecting a second quantity of initial image-text pairs from the first quantity of initial image-text pairs based on a predetermined percentage of data sources and a predetermined percentage of keywords that the first dataset needs to satisfy; and constructing the first dataset by using the second quantity of initial image-text pairs.

Further, the constructing the first dataset by using the second quantity of initial image-text pairs includes: for any initial image-text pair in the second quantity of initial image-text pairs, determining whether an initial image included in the initial image-text pair satisfies a first rule, and whether an initial text included in the initial image-text pair satisfies a second rule; and when a determining result is that the initial image-text pair satisfies both the first rule and the second rule, adding the initial image-text pair to the first dataset.

Further, the first rule includes at least one of the following constraint conditions: a first constraint condition in which an aspect ratio falls within a predetermined ratio interval; a second constraint condition in which any side length falls within a predetermined length interval; and a third constraint condition in which a data amount corresponding to an image falls within a predetermined value interval.

Further, the second rule includes at least one of the following constraint conditions: a fourth constraint condition in which a text length falls within a predetermined character quantity interval; and a fifth constraint condition in which an occurrence frequency of a text in the second quantity of initial image-text pairs falls within a predetermined frequency interval.

Further, after the adding the initial image-text pair to the first dataset, the method further includes: determining an image similarity between images included in all the initial image-text pairs in the first dataset; and selecting several similar initial image-text pairs from all the initial image-text pairs based on the image similarity, retaining one initial image-text pair, and deleting an initial image-text pair similar to the initial image-text pair.

In a possible implementation, the adding all updated image-text pairs and all initial image-text pairs belonging to the high-quality data to a second dataset includes: identifying, one by one, whether all the updated image-text pairs and all the initial image-text pairs belonging to the high-quality data include predetermined sensitive content; and filtering out an updated image-text pair or an initial image-text pair including the sensitive content, and adding remaining updated image-text pairs and remaining initial image-text pairs belonging to the high-quality data to the second dataset.

In a possible implementation, the calculating a similarity score between an initial image and an initial text included in the initial image-text pair includes: for the any initial image-text pair in the first dataset, extracting a first feature vector corresponding to the initial image and a second feature vector corresponding to the initial text included in the initial image-text pair by using a contrastive language-image pre-training (CLIP) model; and calculating a cosine similarity between the first feature vector and the second feature vector, to obtain the similarity score.

In a possible implementation, the generating a corresponding text description based on the initial image includes: inputting the initial image into a bootstrapping language-image pre-training (BLIP) model, and outputting the corresponding text description by using the BLIP model.

According to a second aspect, an apparatus for constructing a dataset for model training is provided. The apparatus includes: an acquisition unit, configured to obtain a first dataset, where the first dataset includes several initial image-text pairs; a calculation unit, configured to: for any initial image-text pair in the first dataset obtained by the acquisition unit, calculate a similarity score between an initial image and an initial text included in the initial image-text pair; a classification unit, configured to classify each initial image-text pair in the first dataset into high-quality data, medium-quality data, or low-quality data based on the similarity score obtained by the calculation unit and a predetermined score threshold; a generation unit, configured to: for any initial image-text pair belonging to the medium-quality data and classified by the classification unit, extract an initial image included in the initial image-text pair, generate a corresponding text description based on the initial image, and form an updated image-text pair by using the initial image and the corresponding text description; and a construction unit, configured to add all updated image-text pairs obtained by the generation unit and all initial image-text pairs belonging to the high-quality data and classified by the classification unit to a second dataset, where the second dataset is used as a dataset for model training.

According to a third aspect, a computer-readable storage medium is provided. The computer-readable storage medium stores a computer program, and when the computer program is executed in a computer, the computer is enabled to perform the method according to the first aspect.

According to a fourth aspect, a computing device is provided, including a memory and a processor. The memory stores executable code, and when the processor executes the executable code, the method according to the first aspect is implemented.

According to the method and the apparatus provided in the embodiments of this specification, first, a first dataset is obtained, where the first dataset includes several initial image-text pairs; then, for any initial image-text pair in the first dataset, a similarity score between an initial image and an initial text included in the initial image-text pair is calculated; then, each initial image-text pair in the first dataset is classified into high-quality data, medium-quality data, or low-quality data based on the similarity score and a predetermined score threshold; then, for any initial image-text pair belonging to the medium-quality data, an initial image included in the initial image-text pair is extracted, a corresponding text description is generated based on the initial image, and an updated image-text pair is formed by using the initial image and the corresponding text description; and finally, all updated image-text pairs and all initial image-text pairs belonging to the high-quality data are added to a second dataset, where the second dataset is used as a dataset for model training. It can be seen from the above-mentioned descriptions that in the embodiments of this specification, a content-based optimization solution is used, each initial image-text pair in the first dataset is classified into high-quality data, medium-quality data, or low-quality data based on the similarity score between the initial image and the initial text, the high-quality data are directly used as training data, and for the medium-quality data, a text description is generated based on an initial image, an updated image-text pair is formed, and the updated image-text pair is used as training data. This implements deep mining of data value and can obtain a sufficient amount of training data satisfying needs, to improve a model training effect.

### BRIEF DESCRIPTION OF DRAWINGS

To describe the technical solutions in the embodiments of the present invention more clearly, the following briefly describes the accompanying drawings needed for describing the embodiments. Clearly, the accompanying drawings in the following description show merely some embodiments of the present invention, and a person of ordinary skill in the art can derive other drawings from these accompanying drawings without creative efforts.

FIG. 1 is a schematic diagram illustrating an implementation scenario of an embodiment, according to this specification;

FIG. 2 is a flowchart illustrating a method for constructing a dataset for model training, according to some embodiments;

FIG. 3 is a schematic diagram illustrating a data cleaning procedure, according to some embodiments; and

FIG. 4 is a schematic block diagram illustrating an apparatus for constructing a dataset for model training, according to some embodiments.

### DESCRIPTION OF EMBODIMENTS

The solutions provided in this specification are described below with reference to the accompanying drawings.

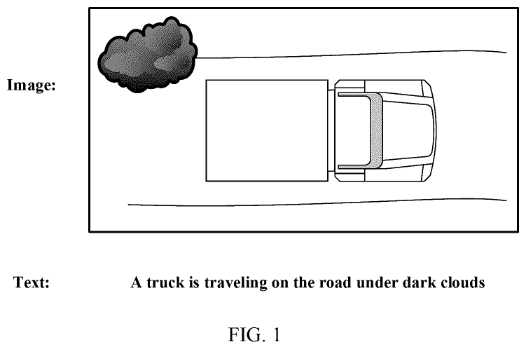

FIG. 1 is a schematic diagram illustrating an implementation scenario of an embodiment, according to this specification. The implementation scenario involves construction of a dataset for model training. With reference to FIG. 1, the dataset includes a plurality of image-text pairs. An image-text pair is a combination of an image and a text. An image and a text in the same image-text pair need to be related in content, to achieve a good model training effect. For example, in an image-text pair shown in FIG. 1, black clouds, a truck, and a road are displayed in an image, and a text is “A truck is traveling on the road under dark clouds”. It can be seen that the image and the text are related in content. Images and texts are two different modalities. The modality is a representation form of things and is a description of things from a specific perspective. Multimodality usually includes two or more modality forms and refers to descriptions of things from a plurality of perspectives.

Multimodality can correspond to information of a plurality of modalities, including texts, images, videos, audio, etc., and specifically refers to images and texts in the embodiments of this specification.

Usually, image-text pairs in a dataset are from an Internet environment and are obtained through crawling, and crawled data may be of low quality. For example, an image and a text included in an image-text pair are unrelated, and if the data are added to training, a model training effect is undoubtedly adversely affected. Data cleaning can be performed on data crawled from the Internet. Data cleaning is a data optimization and filtering procedure in which low-quality data can be filtered out to obtain high-quality structured data that can be used for training. In a conventional data cleaning method, only rule-based data cleaning is usually used, that is, filtering is performed by using a simple image dimension, ratio, size, or text length. In this filtering solution, some image-text pairs whose objective image and text attributes are of relatively poor quality can be filtered out, but image-text pairs whose content is completely unrelated cannot be filtered out. In addition, high-quality data usually account for only 10% of the crawled data, and if a large amount of medium-quality data is discarded, a waste of valuable data is caused, and a data scale cannot be efficiently expanded.

Therefore, in the embodiments of this specification, a corresponding optimization solution is proposed for construction of a dataset for model training, so that a sufficient amount of training data satisfying needs can be obtained, to improve a model training effect.

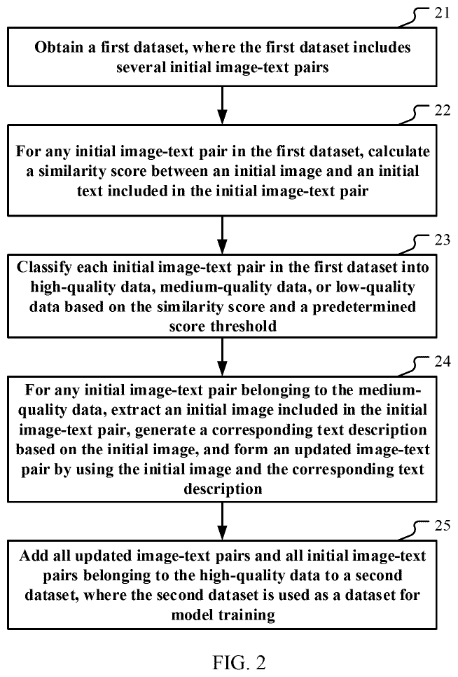

FIG. 2 is a flowchart illustrating a method for constructing a dataset for model training, according to some embodiments. The method can be based on the implementation scenario shown in FIG. 1. As shown in FIG. 2, the method for constructing a dataset for model training in the embodiments includes the following steps: Step 21: Obtain a first dataset, where the first dataset includes several initial image-text pairs. Step 22: For any initial image-text pair in the first dataset, calculate a similarity score between an initial image and an initial text included in the initial image-text pair. Step 23: Classify each initial image-text pair in the first dataset into high-quality data, medium-quality data, or low-quality data based on the similarity score and a predetermined score threshold. Step 24: For any initial image-text pair belonging to the medium-quality data, extract an initial image included in the initial image-text pair, generate a corresponding text description based on the initial image, and form an updated image-text pair by using the initial image and the corresponding text description. Step 25: Add all updated image-text pairs and all initial image-text pairs belonging to the high-quality data to a second dataset, where the second dataset is used as a dataset for model training. The following describes specific execution methods of the above-mentioned steps.

First, in step 21, the first dataset is obtained, where the first dataset includes several initial image-text pairs. It can be understood that the initial image-text pair included in the first dataset may include a case in which there is low relevance between an image and a text, and data cleaning needs to be performed.

In an example, the obtaining a first dataset includes: obtaining a first quantity of initial image-text pairs from a plurality of data sources, and analyzing a keyword that matches each initial image-text pair; selecting a second quantity of initial image-text pairs from the first quantity of initial image-text pairs based on a predetermined percentage of data sources and a predetermined percentage of keywords that the first dataset needs to satisfy; and constructing the first dataset by using the second quantity of initial image-text pairs.

In this example, the data source can refer to an Internet protocol IP address, and basic information about data is obtained, to know a percentage of data sources and a percentage of keyword content, so as to ensure diversity of data in the first dataset.

Further, the constructing the first dataset by using the second quantity of initial image-text pairs includes: for any initial image-text pair in the second quantity of initial image-text pairs, determining whether an initial image included in the initial image-text pair satisfies a first rule, and whether an initial text included in the initial image-text pair satisfies a second rule; and when a determining result is that the initial image-text pair satisfies both the first rule and the second rule, adding the initial image-text pair to the first dataset.

In this example, when rule-based data cleaning, which can also be referred to as rule-based optimization, is used, some image-text pairs whose objective image and text attributes are of relatively poor quality can be filtered out.

Further, the first rule includes at least one of the following constraint conditions: a first constraint condition in which an aspect ratio falls within a predetermined ratio interval; a second constraint condition in which any side length falls within a predetermined length interval; and a third constraint condition in which a data amount corresponding to an image falls within a predetermined value interval.

In this example, the first rule is a rule set for an image, and data cleaning based on the first rule can also be referred to as image cleaning optimization. The first constraint condition can filter out an excessively long image. For example, the first constraint condition is that an aspect ratio is less than or equal to 3, and an image whose aspect ratio is greater than 3 is usually content such as an advertisement or a title without explicit semantic value, and is not suitable for being used as training data. The second constraint condition can filter out an image with an excessively small size. For example, the second constraint condition is that any side length is greater than or equal to 200, and can filter out an image whose any side length is less than 200. The third constraint condition can filter out an image with an excessively small data amount. For example, the third constraint condition is that a data amount of an image is greater than or equal to 5 KB, and can filter out an image with a data amount less than 5 KB, to remove content with low resolution.

Further, the second rule includes at least one of the following constraint conditions: a fourth constraint condition in which a text length falls within a predetermined character quantity interval; and a fifth constraint condition in which an occurrence frequency of a text in the second quantity of initial image-text pairs falls within a predetermined frequency interval.

In this example, the second rule is a rule set for a text, and data cleaning based on the second rule can also be referred to as text cleaning optimization. The fourth constraint condition can filter out an excessively short text. For example, the fourth constraint condition is that a character quantity is greater than 60, and can filter out a text whose character quantity ranges from 1 to 60. The fifth constraint condition can filter out a high-frequency text. For example, the fifth constraint condition is that an occurrence frequency is less than or equal to 20, and can filter out a text with an occurrence frequency greater than 20. There are the following types of high-frequency texts: texts clearly having no image-text relevance such as “images”, “logs”, “home pages”, and “image browsing”; platform names such as “* blog”, “** Content Open Platform”, “** Express”, and “** Book”; website names such as “China ** Public Network” and “** Daily News Network”; etc.

Further, after the adding the initial image-text pair to the first dataset, the method further includes: determining an image similarity between images included in all the initial image-text pairs in the first dataset; and selecting several similar initial image-text pairs from all the initial image-text pairs based on the image similarity, retaining one initial image-text pair, and deleting an initial image-text pair similar to the initial image-text pair.

In this example, when content-based data cleaning, which can also be referred to as content-based optimization, is used, some image-text pairs with duplicate image and text content can be filtered out through content deduplication. For example, to ensure diversity of training data and a one-to-one mapping relationship of the image-text pair, a pHash algorithm is used to quickly deduplicate large-scale image content.

Then, in step 22, for the any initial image-text pair in the first dataset, the similarity score between the initial image and the initial text included in the initial image-text pair is calculated. It can be understood that the similarity score identifies a degree to which the initial image and the initial text are similar. The degree is also referred to as image-text relevance. Usually, a higher similarity score indicates a higher similarity between the initial image and the initial text.

The image-text relevance usually means to evaluate a similarity or relevance between a given image and a text query in a visual retrieval or visual inference task. The similarity usually can be measured by embedding the image and the text into the same vector space and then calculating a cosine similarity, a Euclidean distance, etc. between the image and the text.

In an example, the calculating a similarity score between an initial image and an initial text included in the initial image-text pair includes: for the any initial image-text pair in the first dataset, extracting a first feature vector corresponding to the initial image and a second feature vector corresponding to the initial text included in the initial image-text pair by using a contrastive language-image pre-training (CLIP) model; and calculating a cosine similarity between the first feature vector and the second feature vector, to obtain the similarity score.

The CLIP model has a Chinese version Chinese-CLIP that is trained by using large-scale Chinese data, uses approximately 200 million of image-text pairs, and is intended to help users quickly implement tasks such as image-text feature extraction, similarity calculation, cross-modal retrieval, and zero-sample image classification in the Chinese field.

Then, in step 23, each initial image-text pair in the first dataset is classified into high-quality data, medium-quality data, or low-quality data based on the similarity score and the predetermined score threshold. It can be understood that a similarity score of the high-quality data is greater than a similarity score of the medium-quality data, and the similarity score of the medium-quality data is greater than a similarity score of the low-quality data.

In the embodiments of this specification, another classification method can alternatively be used. For example, all the initial image-text pairs in the first dataset are classified into two types: high-quality data and medium-quality data.

Then, in step 24, for the any initial image-text pair belonging to the medium-quality data, the initial image included in the initial image-text pair is extracted, the corresponding text description is generated based on the initial image, and an updated image-text pair is formed by using the initial image and the corresponding text description. It can be understood that an initial image and a corresponding text description in the updated image-text pair usually have a relatively high similarity score, and can be classified into high-quality data.

In an example, the generating a corresponding text description based on the initial image includes: inputting the initial image into a bootstrapping language-image pre-training (BLIP) model, and outputting the corresponding text description by using the BLIP model.

The BLIP model can be specifically BLIP2. The BLIP model is a general and efficient pre-trained model, and can guide vision-language pre-training by using an existing frozen pre-trained image encoder and a frozen large language model, to support generation of a text description for an image.

In the embodiments of this specification, any initial image-text pair belonging to the low-quality data can be directly filtered out, or a processing method similar to that for the medium-quality data is used to generate an updated image-text pair. For example, for any initial image-text pair belonging to the low-quality data, an initial image included in the initial image-text pair is extracted, a corresponding text description is generated based on the initial image, and an updated image-text pair is formed by using the initial image and the corresponding text description.

Finally, in step 25, all the updated image-text pairs and all the initial image-text pairs belonging to the high-quality data are added to the second dataset, where the second dataset is used as a dataset for model training. It can be understood that it can be considered, by default, that the updated image-text pair belongs to the high-quality data, and is directly added to the second dataset, or it is further determined whether the updated image-text pair belongs to the high-quality data, and an updated image-text pair belonging to the high-quality data is added to the second dataset.

In an example, the adding all updated image-text pairs and all initial image-text pairs belonging to the high-quality data to a second dataset includes: identifying, one by one, whether all the updated image-text pairs and all the initial image-text pairs belonging to the high-quality data include predetermined sensitive content; and filtering out an updated image-text pair or an initial image-text pair including the sensitive content, and adding remaining updated image-text pairs and remaining initial image-text pairs belonging to the high-quality data to the second dataset.

In this example, data security optimization is performed. For data from the open Internet world, it is also important to remove content related to vulgarity, pornography, politics, violence, terrorism, and personal privacy, and other sensitive content from the data. Such risky data can be filtered out in the embodiments of this specification.

The second dataset constructed in the embodiments of this specification can be used to train a plurality of models, for example, a multimodal large model, a generative large model, an image-text understanding model, and a video understanding model. A self-supervised learning method is used for model training. Self-supervised learning is a machine learning method, and means to train a model by using unlabeled data to determine useful features or patterns in the data.

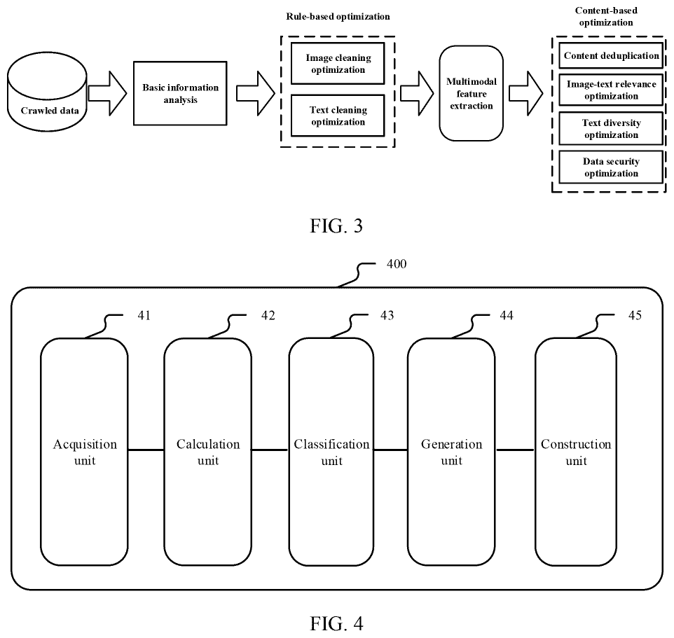

FIG. 3 is a schematic diagram illustrating a data cleaning procedure, according to some embodiments. With reference to FIG. 3, for crawled data, to ensure data diversity, basic information analysis is first performed on the data, to know a percentage of data sources and a percentage of keyword content. Then, a cleaning phase is entered and mainly includes two aspects of optimization: rule-based optimization and content-based optimization. Rule-based optimization includes image cleaning optimization and text cleaning optimization. Then, multi-modal feature extraction is performed, and content-based optimization is performed by using extracted features. Content-based optimization includes content deduplication, image-text relevance optimization, text diversity optimization, and data security optimization. After the above-mentioned processing procedure is performed, low-quality data involving personal privacy or insecure data are filtered out. As such, a subsequent model training effect is improved, and no risky content is generated in understanding and generation tasks, to avoid causing public opinion.

In the embodiments of this specification, for the constructed dataset for model training, a perfect data quality evaluation method is further proposed, to ensure that the obtained image and text data are truly valid and secure.

A data quality evaluation method is manual evaluation in which manual labeling is used and quality of data is evaluated by sampling and labeling a plurality of image-text pairs in a dataset. Evaluation dimensions can include: low-quality content that is texts with unclear semantics and chaotic formatting; advertising content that is intended for advertising purposes; vulgar content that is content not in compliance with laws and regulations, including types that promote violence, murder, malicious abuse, insults and defamation of others, pornography, etc.; biased content that is content that discriminates against different individuals or groups, for example, occupational discrimination; incorrect tendency that is content having a negative tendency and inconsistent with the Party's long-term guidelines, current policies, and mainstream ideas; and normal content that is texts other than those in the above-mentioned cases.

Another data quality evaluation method is model evaluation in which iteration is performed for the same quantity of times by using the same small model, and model effects before and after optimization are compared.

According to the method provided in the embodiments of this specification, first, a first dataset is obtained, where the first dataset includes several initial image-text pairs; then, for any initial image-text pair in the first dataset, a similarity score between an initial image and an initial text included in the initial image-text pair is calculated; then, each initial image-text pair in the first dataset is classified into high-quality data, medium-quality data, or low-quality data based on the similarity score and a predetermined score threshold; then, for any initial image-text pair belonging to the medium-quality data, an initial image included in the initial image-text pair is extracted, a corresponding text description is generated based on the initial image, and an updated image-text pair is formed by using the initial image and the corresponding text description; and finally, all updated image-text pairs and all initial image-text pairs belonging to the high-quality data are added to a second dataset, where the second dataset is used as a dataset for model training. It can be seen from the above-mentioned descriptions that in the embodiments of this specification, a content-based optimization solution is used, each initial image-text pair in the first dataset is classified into high-quality data, medium-quality data, or low-quality data based on the similarity score between the initial image and the initial text, the high-quality data are directly used as training data, and for the medium-quality data, a text description is generated based on an initial image, an updated image-text pair is formed, and the updated image-text pair is used as training data. This implements deep mining of data value and can obtain a sufficient amount of training data satisfying needs, to improve a model training effect.

According to an embodiment in another aspect, an apparatus for constructing a dataset for model training is further provided. The apparatus is configured to perform the method provided in the embodiments of this specification. FIG. 4 is a schematic block diagram illustrating an apparatus for constructing a dataset for model training, according to some embodiments. As shown in FIG. 4, the apparatus 400 includes: an acquisition unit 41, configured to obtain a first dataset, where the first dataset includes several initial image-text pairs; a calculation unit 42, configured to: for any initial image-text pair in the first dataset obtained by the acquisition unit 41, calculate a similarity score between an initial image and an initial text included in the initial image-text pair; a classification unit 43, configured to classify each initial image-text pair in the first dataset into high-quality data, medium-quality data, or low-quality data based on the similarity score obtained by the calculation unit 42 and a predetermined score threshold; a generation unit 44, configured to: for any initial image-text pair belonging to the medium-quality data and classified by the classification unit 43, extract an initial image included in the initial image-text pair, generate a corresponding text description based on the initial image, and form an updated image-text pair by using the initial image and the corresponding text description; and a construction unit 45, configured to add all updated image-text pairs obtained by the generation unit 44 and all initial image-text pairs belonging to the high-quality data and classified by the classification unit 43 to a second dataset, where the second dataset is used as a dataset for model training.

Optionally, in an embodiment, the acquisition unit 41 includes: an acquisition subunit, configured to obtain a first quantity of initial image-text pairs from a plurality of data sources, and analyze a keyword that matches each initial image-text pair; a selection subunit, configured to select, based on a predetermined percentage of data sources and a predetermined percentage of keywords that the first dataset needs to satisfy, a second quantity of initial image-text pairs from the first quantity of initial image-text pairs obtained by the acquisition subunit; and a construction subunit, configured to construct the first dataset by using the second quantity of initial image-text pairs obtained by the selection subunit.

Further, the construction subunit is specifically configured to: for any initial image-text pair in the second quantity of initial image-text pairs, determine whether an initial image included in the initial image-text pair satisfies a first rule, and whether an initial text included in the initial image-text pair satisfies a second rule; and when a determining result is that the initial image-text pair satisfies both the first rule and the second rule, add the initial image-text pair to the first dataset.

Further, the first rule includes at least one of the following constraint conditions: a first constraint condition in which an aspect ratio falls within a predetermined ratio interval; a second constraint condition in which any side length falls within a predetermined length interval; and a third constraint condition in which a data amount corresponding to an image falls within a predetermined value interval.

Further, the second rule includes at least one of the following constraint conditions: a fourth constraint condition in which a text length falls within a predetermined character quantity interval; and a fifth constraint condition in which an occurrence frequency of a text in the second quantity of initial image-text pairs falls within a predetermined frequency interval.

Further, the construction subunit is further configured to: after the initial image-text pair is added to the first dataset, determine an image similarity between images included in all the initial image-text pairs in the first dataset; and select several similar initial image-text pairs from all the initial image-text pairs based on the image similarity, retain one initial image-text pair, and delete an initial image-text pair similar to the initial image-text pair.

Optionally, in an embodiment, the construction unit 45 includes: an identification subunit, configured to identify, one by one, whether all the updated image-text pairs and all the initial image-text pairs belonging to the high-quality data include predetermined sensitive content; and a filtering subunit, configured to filter out an updated image-text pair or an initial image-text pair including the sensitive content, and add remaining updated image-text pairs and remaining initial image-text pairs belonging to the high-quality data to the second dataset.

Optionally, in an embodiment, the calculation unit 42 includes: a feature extraction subunit, configured to: for the any initial image-text pair in the first dataset, extract a first feature vector corresponding to the initial image and a second feature vector corresponding to the initial text included in the initial image-text pair by using a contrastive language-image pre-training CLIP model; and a calculation subunit, configured to calculate a cosine similarity between the first feature vector and the second feature vector, to obtain the similarity score.

Optionally, in an embodiment, the generation unit 44 is specifically configured to input the initial image into a bootstrapping language-image pre-training BLIP model, and output the corresponding text description by using the BLIP model.

According to the apparatus provided in the embodiments of this specification, first, the acquisition unit 41 obtains a first dataset, where the first dataset includes several initial image-text pairs; then, for any initial image-text pair in the first dataset, the calculation unit 42 calculates a similarity score between an initial image and an initial text included in the initial image-text pair; then, the classification unit 43 classifies each initial image-text pair in the first dataset into high-quality data, medium-quality data, or low-quality data based on the similarity score and a predetermined score threshold; then, for any initial image-text pair belonging to the medium-quality data, the generation unit 44 extracts an initial image included in the initial image-text pair, generates a corresponding text description based on the initial image, and forms an updated image-text pair by using the initial image and the corresponding text description; and finally, the construction unit 45 adds all updated image-text pairs and all initial image-text pairs belonging to the high-quality data to a second dataset, where the second dataset is used as a dataset for model training. It can be seen from the above-mentioned descriptions that in the embodiments of this specification, a content-based optimization solution is used, each initial image-text pair in the first dataset is classified into high-quality data, medium-quality data, or low-quality data based on the similarity score between the initial image and the initial text, the high-quality data are directly used as training data, and for the medium-quality data, a text description is generated based on an initial image, an updated image-text pair is formed, and the updated image-text pair is used as training data. This implements deep mining of data value and can obtain a sufficient amount of training data satisfying needs, to improve a model training effect.

According to an embodiment in another aspect, a computer-readable storage medium is further provided. The computer-readable storage medium stores a computer program. When the computer program is executed in a computer, the computer is enabled to perform the method described with reference to FIG. 2.

According to an embodiment in still another aspect, a computing device is further provided, including a memory and a processor. The memory stores executable code, and when the processor executes the executable code, the method described with reference to FIG. 2 is implemented.

A person skilled in the art should be aware that in the above-mentioned one or more examples, the functions described in the present invention can be implemented by hardware, software, firmware, or any combination thereof. When being implemented by software, these functions can be stored in a computer-readable medium or transmitted as one or more instructions or code on a computer-readable medium.

In the above-mentioned specific implementations, the objectives, technical solutions, and beneficial effects of the present invention are further described in detail. It should be understood that the above-mentioned descriptions are merely specific implementations of the present invention, but are not intended to limit the protection scope of the present invention. Any modification, equivalent replacement, improvement, etc. made based on the technical solutions of the present invention shall fall within the protection scope of the present invention.

1. A method for model training, wherein the method comprises:
obtaining a first dataset that comprises a plurality of initial image-text pairs;
calculating a similarity score between an initial image and an initial text comprised in each of the plurality of initial image-text pair;
classifying each of the plurality of initial image-text pairs as one of high-quality data, medium-quality data, or low-quality data based on the similarity score and a predetermined score threshold;
for initial image-text pairs classified as the medium-quality data:
extracting initial images comprised in the initial image-text pairs;
generating corresponding text descriptions based on the initial images; and
forming updated image-text pairs based on the initial images and the corresponding text descriptions; and
adding the updated image-text pairs classified as the medium-quality data and initial image-text pairs classified as the high-quality data to a second dataset for model training.

2. The method according to claim 1, wherein the obtaining a first dataset comprises:
obtaining a first quantity of initial image-text pairs from a plurality of data sources, and analyzing a keyword that matches each of the plurality of initial image-text pairs;
selecting a second quantity of initial image-text pairs from the first quantity of initial image-text pairs based on a predetermined percentage of data sources and a predetermined percentage of keywords that the first dataset needs to satisfy; and
constructing the first dataset by using the second quantity of initial image-text pairs.

3. The method according to claim 2, wherein the constructing the first dataset by using the second quantity of initial image-text pairs comprises:
for each image-text pair in the second quantity of initial image-text pairs;
determining whether an initial image comprised in the corresponding initial image-text pair satisfies a first rule, and whether an initial text comprised in the initial image-text pair satisfies a second rule; and
in response to determining that the initial image-text pair the first rule and the second rule are satisfied, adding the initial image-text pair to the first dataset.

4. The method according to claim 3, wherein the first rule comprises one or more conditions of an image, the one or more conditions comprising:
an aspect ratio falls within a predetermined ratio interval;
a side length falls within a predetermined length interval; and
a data amount corresponding to the image falls within a predetermined value interval.

5. The method according to claim 3, wherein the second rule comprises one or more conditions of a text, the one or more conditions comprising:
a text length falls within a predetermined character quantity interval; and
an occurrence frequency of the text in the second quantity of initial image-text pairs falls within a predetermined frequency interval.

6. The method according to claim 3, wherein after the adding the initial image-text pair to the first dataset, the method further comprises:
determining an image similarity between images comprised in the initial image-text pairs in the first dataset;
selecting a plurality of similar initial image-text pairs from the initial image-text pairs based on the image similarity; and
keeping one of the plurality of similar initial image-text pairs and deleting a remainder of the plurality of similar initial image-text pairs.

7. The method according to claim 1, the method further comprises:
determining whether the updated image-text pairs classified as the medium-quality data and initial image-text pairs classified as the high-quality data comprise predetermined sensitive content; and
wherein the adding the updated image-text pairs classified as the medium-quality data and initial image-text pairs classified as the high-quality data to a second dataset for model training comprises:
adding updated image-text pairs classified as the medium-quality data and initial image-text pairs classified as the high-quality data that do not comprise the predetermined sensitive content.

8. The method according to claim 1, wherein the calculating a similarity score between an initial image and an initial text comprised in each of the plurality of initial image-text pairs comprises:
extracting a first feature vector corresponding to the initial image and a second feature vector based on a contrastive language-image pre-training (CLIP) model; and
calculating the similarity score based on determining a cosine similarity between the first feature vector and the second feature vector.

9. The method according to claim 1, wherein the generating corresponding text descriptions based on the initial images comprises:
inputting the initial images into a bootstrapping language-image pre-training (BLIP) model; and
generating the corresponding text descriptions based on the BLIP model.

10. An apparatus for model training, wherein the apparatus comprises:
at least one processor; and
one or more memories coupled to the at least one processor for storing programming instructions to perform operations comprising:
obtaining a first dataset that comprises a plurality of initial image-text pairs;
calculating a similarity score between an initial image and an initial text comprised in each of the plurality of initial image-text pair;
classifying each of the plurality of initial image-text pairs as one of high-quality data, medium-quality data, or low-quality data based on the similarity score and a predetermined score threshold;
for initial image-text pairs classified as the medium-quality data:
extracting initial images comprised in the initial image-text pairs;
generating corresponding text descriptions based on the initial images; and
forming updated image-text pairs based on the initial images and the corresponding text descriptions; and
adding the updated image-text pairs classified as the medium-quality data and initial image-text pairs classified as the high-quality data to a second dataset for model training.

11. The apparatus according to claim 10, wherein the obtaining a first dataset comprises:
obtaining a first quantity of initial image-text pairs from a plurality of data sources, and analyzing a keyword that matches each of the plurality of initial image-text pairs;
selecting a second quantity of initial image-text pairs from the first quantity of initial image-text pairs based on a predetermined percentage of data sources and a predetermined percentage of keywords that the first dataset needs to satisfy; and
constructing the first dataset by using the second quantity of initial image-text pairs.

12. The apparatus according to claim 11, wherein the constructing the first dataset by using the second quantity of initial image-text pairs comprises:
for each image-text pair in the second quantity of initial image-text pairs;
determining whether an initial image comprised in the corresponding initial image-text pair satisfies a first rule, and whether an initial text comprised in the initial image-text pair satisfies a second rule; and
in response to determining that the initial image-text pair the first rule and the second rule are satisfied, adding the initial image-text pair to the first dataset.

13. The apparatus according to claim 12, wherein the first rule comprises one or more conditions of an image, the one or more conditions comprising:
an aspect ratio falls within a predetermined ratio interval;
a side length falls within a predetermined length interval; and
a data amount corresponding to the image falls within a predetermined value interval.

14. The apparatus according to claim 12, wherein the second rule comprises one or more conditions of a text, the one or more conditions comprising:
a text length falls within a predetermined character quantity interval; and
an occurrence frequency of the text in the second quantity of initial image-text pairs falls within a predetermined frequency interval.

15. The apparatus according to claim 12, wherein after the adding the initial image-text pair to the first dataset, the operations further comprise:
determining an image similarity between images comprised in the initial image-text pairs in the first dataset;
selecting a plurality of similar initial image-text pairs from the initial image-text pairs based on the image similarity; and
keeping one of the plurality of similar initial image-text pairs and deleting a remainder of the plurality of similar initial image-text pairs.

16. The apparatus according to claim 10, the operations further comprise:
determining whether the updated image-text pairs classified as the medium-quality data and initial image-text pairs classified as the high-quality data comprise predetermined sensitive content; and
wherein the adding the updated image-text pairs classified as the medium-quality data and initial image-text pairs classified as the high-quality data to a second dataset for model training comprises:
adding updated image-text pairs classified as the medium-quality data and initial image-text pairs classified as the high-quality data that do not comprise the predetermined sensitive content.

17. The apparatus according to claim 10, wherein the calculating a similarity score between an initial image and an initial text comprised in each of the plurality of initial image-text pairs comprises:
extracting a first feature vector corresponding to the initial image and a second feature vector based on a contrastive language-image pre-training (CLIP) model; and
calculating the similarity score based on determining a cosine similarity between the first feature vector and the second feature vector.

18. The apparatus according to claim 10, wherein the generating corresponding text descriptions based on the initial images comprises:
inputting the initial images into a bootstrapping language-image pre-training (BLIP) model; and
generating the corresponding text descriptions based on the BLIP model.

19. A non-transitory computer-readable storage medium storing programming instructions for execution by one or more processors to perform operations comprising:
obtaining a first dataset that comprises a plurality of initial image-text pairs;
calculating a similarity score between an initial image and an initial text comprised in each of the plurality of initial image-text pair;
classifying each of the plurality of initial image-text pairs as one of high-quality data, medium-quality data, or low-quality data based on the similarity score and a predetermined score threshold;
for initial image-text pairs classified as the medium-quality data:
extracting initial images comprised in the initial image-text pairs;
generating corresponding text descriptions based on the initial images; and
forming updated image-text pairs based on the initial images and the corresponding text descriptions; and
adding the updated image-text pairs classified as the medium-quality data and initial image-text pairs classified as the high-quality data to a second dataset for model training.

20. The non-transitory computer-readable storage medium according to claim 19, wherein the obtaining a first dataset comprises:
obtaining a first quantity of initial image-text pairs from a plurality of data sources, and analyzing a keyword that matches each of the plurality of initial image-text pairs;
selecting a second quantity of initial image-text pairs from the first quantity of initial image-text pairs based on a predetermined percentage of data sources and a predetermined percentage of keywords that the first dataset needs to satisfy; and
constructing the first dataset by using the second quantity of initial image-text pairs.
